(19) United States
(12) Patent Application Publication
(10) Pub. No.: US 2008/0276034 A1
(43) Pub. Date: Nov. 6, 2008

(54) Design Structure for Transmitting Data in an Integrated Circuit

(76) Inventors: W. Riyon Harding, Richmond, VT (US); David W. Milton, Underhill, VT (US); Clarence Rosser Ogilvie, Huntington, VT (US); Jason E. Rotella, Mineville, NY (US); Paul M. Schanely, Essex Junction, VT (US); Sebastian T. Ventrone, South Burlington, VT (US)

Correspondence Address: IBM MICROELECTRONICS;INTELLECTUAL PROPERTY LAW, 1000 RIVER STREET, 972 E, ESSEX JUNCTION, VT, 05452, US

(21) Appl. No.: 12/179,597

(22) Filed: Jul. 25, 2008

Related U.S. Application Data
(63) Continuation-in-part of application No. 11/276,449, filed on Feb. 28, 2006.

(51) Int. Cl. G06F 13/00

(52) U.S. Cl. 710/316

(57) ABSTRACT

A design structure, which may be generated by a fabless design company, for transmitting data between cores residing in an integrated circuit. Data is transmitted by using hubs located between the cores and an arbiter. The arbiter maintains a table that contains all the valid combinations of routing paths between the cores.

### CROSS-REFERENCE TO RELATED APPLICATIONS

The present application is a continuation in part of U.S. patent application Ser. No. 11/276,449 filed Feb. 28, 2006 and assigned to the present Assignee.

### BACKGROUND

1. Technical Field

The present invention generally relates to integrated circuits and, more specifically, to the design process used by a fabless design company when designing circuitry that promotes communication of data between cores that reside in an integrated circuit.

2. Description of Related Art

As manufacturing processes continue to become more complex and of smaller geometries, error-free communication of data between functional cores of an integrated circuit without introducing additional problems from noise, available space, and other similar issues is becoming increasingly difficult. Current methods for providing this communicated data use point-to-point or similar wiring techniques such as shared buses. Unfortunately, as integration density continues to increase, these techniques are becoming inefficient and prone to the introduction of errors.

It would, therefore, be a distinct advantage to have a method and apparatus that could transfer data from one core to another while reducing the issues typically associated with point-to-point wiring techniques and the like.

### SUMMARY OF THE PRESENT INVENTION

In one embodiment of the invention, a design process is used to generate the capability of transmitting data in an integrated circuit. The design process includes the steps of creating multiple cores that implement a desired function and creating multiple hubs that transmit data between the cores. The method further includes the step of designing a table that contains all valid path routings for data to travel from a source core of the multiple cores to a destination core of the multiple cores using one or more of the hubs. The design process also includes designing for selecting one of the valid path routings for transmitting data from a first source core to a first destination core. In addition, the design process also includes designing for transmitting the data according to the selected path routing from the first source core to the first destination core.

### BRIEF DESCRIPTION OF THE DRAWINGS

The present invention will be better understood and its advantages will become more apparent to those skilled in the art by reference to the following drawings, in conjunction with the accompanying specification, in which:

FIG. 1 is a diagram of an integrated circuit that implements a communication system of a preferred embodiment of the present invention;

FIG. 2 is a flow chart illustrating the method for transmitting data from a source core to a destination core of FIG. 1 according to the teachings of a preferred embodiment of the present invention;

FIG. 3 is a data structure illustrating an example of how a header of a data packet can be constructed according to the teachings of the preferred embodiment of the present invention;

FIG. 4 is a flow chart illustrating the method used by the arbiter and a destination hub of FIG. 1 to store relevant transmission history information according to the preferred embodiment of the present invention;

FIG. 5 is a data structure illustrating the header example of FIG. 3 updated to reflect the time spent at certain hubs of FIG. 1 during its transmission according to the teachings of the preferred embodiment of the present invention;

FIG. 6 is a diagram illustrating a table that is used by the arbiter of FIG. 1 for saving path routing information received from a destination core according to the teachings of the preferred embodiment of the present invention;

FIG. 7 is a diagram illustrating the updating of the table of FIG. 6 to reflect path routing information according to the teachings of the preferred embodiment of the present invention;

FIG. 8 is a schematic diagram illustrating in greater detail a selected hub of FIG. 1 according to the teachings of the preferred embodiment of the present invention;

FIG. 9 is a flow chart illustrating the method used by a hub such as the selected hub of FIG. 8 for receiving packet data from another hub or core according to the teachings of the preferred embodiment of the present invention;

FIG. 10 is a flow chart illustrating the transmission of data packets by a hub of FIG. 1 according to the teachings of a preferred embodiment of the present invention; and

FIG. 11 is a flow diagram of a design flow process often used in the design of semiconductors prior to manufacturing.

### DETAILED DESCRIPTION

An embodiment of the present invention is a design structure for transmitting data between cores in an integrated circuit using hubs/routers that are coupled one to another. The data is segmented into data packets and transmitted from a source core to a destination core. Each data packet includes a header for specifying its path route from the source core to the destination core and the time spent at hub/routers. This information is centrally maintained and updated in an arbiter that organizes the information according to source to destination path and time. Prior to transmitting data, the source core queries the arbiter to determine which of the available paths is appropriate for the transmission.

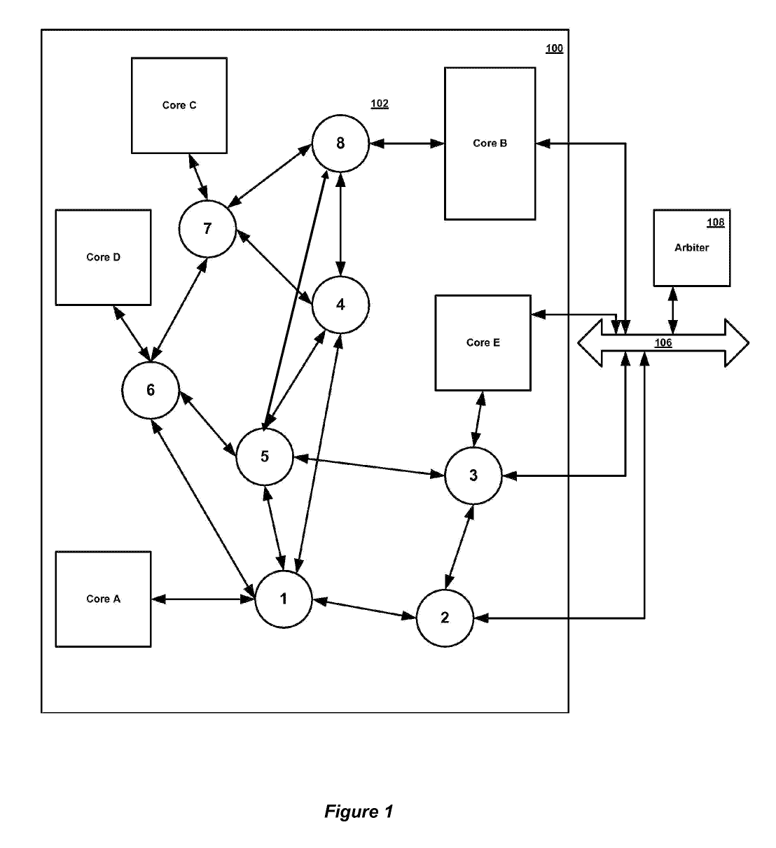

Reference now being made to FIG. 1, a diagram of an integrated circuit 100 is shown that implements a communication system 102 of a preferred embodiment of the present invention. The communication system 102 includes a plurality of cores A-E, an arbiter 108, arbiter bus 106, and hubs/routers 1-8. In order to simplify the ease with which the present invention can be understood and explained, a limited number of cores and hubs have been illustrated. In practice, the number of cores and hubs would be numerous and dependent upon the particular design being implemented.

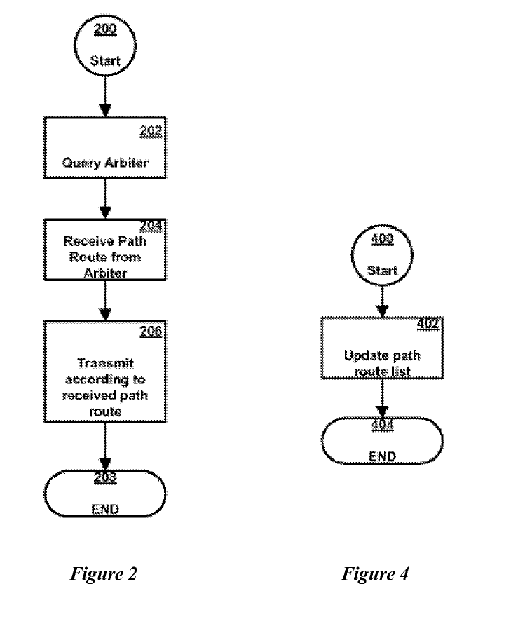

Each one of the hubs 1-8 is coupled to another hub 1-8 or core A-E in such a fashion so as to provide communication of data between cores A-E in accordance with transfer timing (e.g., synchronous or asynchronous) and design constraints. In addition, each of the hubs 1-8 and cores A-E communicate with the arbiter 108 using the arbiter bus 106 (each core A-B is coupled to the arbiter bus 106) as described in connection with FIG. 2 below.

Reference now being made to FIG. 2 a flow chart is shown illustrating the method for transmitting data from a source core to a destination core of FIG. 1 according to the teachings of a preferred embodiment of the present invention. The transmission of data from a source core (e.g., Core A) to a destination core (e.g., Core B) can take several different paths (e.g., hubs (1->5->8), (1->5->4->8), (1->6->7->8), (1->2->4->8), etc.). Some of these paths may be congested or otherwise unavailable.

Prior to transmitting data packets, the source core will query the arbiter 108 for a routing path to the destination core (Steps 200-202). The arbiter 108 is responsible for storing the potential paths for transmission of data from any one of the cores A-B to another core A-B and updating the time it takes for the data to actually travel one of these paths in real time as explained in connection with FIG. 4.

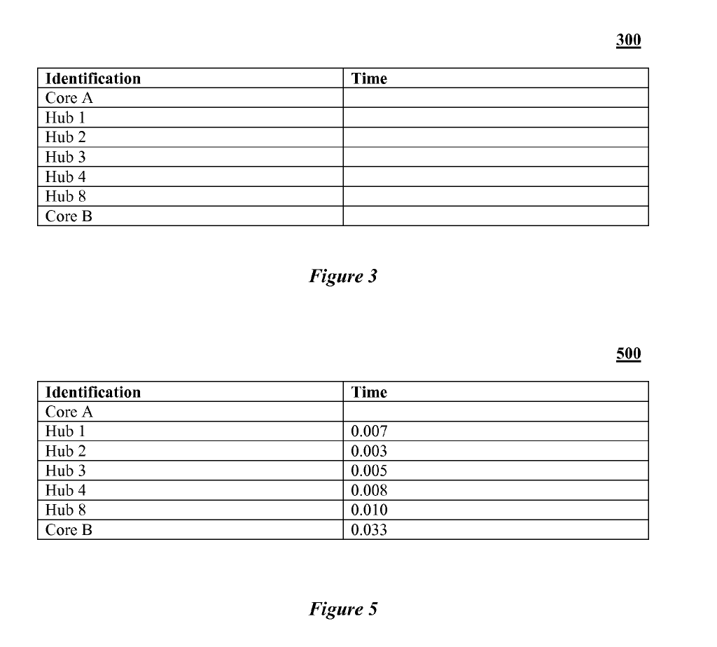

Based upon certain criteria such as time to reach the destination core and priority, the arbiter 108 upon receiving this request will return the routing path in the form of a header such as the example header 300 illustrated in FIG. 3 (Step 204). The header 300 includes the path the data packet should take from source core A to destination core B. In this example, the routing path is hubs 1, 2, 3, 4, and 8.

In the preferred embodiment of the present invention, as the data packet travels from one hub to another, the time spent at the hub is recorded in the header of the data packet. Alternatively, the total time it takes for the transmission of the data packet from the source core to the destination core can be stored on any other means for indicating the relative congestion of the routing path.

In accordance with the preferred embodiment of the present invention, the header 300 includes a time storage location with each hub designation. In this case, since the transmission of the header is just beginning, the time storage fields are blank or otherwise initialized.

Upon receiving the path route, the source core A, generates data packets containing the header 200 and transmits them to hub 1 (Steps 206-208) where they are further transmitted according to the indicated routing path.

Reference now being made to FIG. 4, a flow chart is shown illustrating the method used by the arbiter 108 and a destination core of FIG. 1 to store relevant transmission history information according to the preferred embodiment of the present invention. When a destination core receives a data packet from an adjacent hub, it transmits the header 200 information to the arbiter 108 with an indication of the time spent at each hub or the total transmission time for the indicated path route (Step 400). In the present example, the header of a received data packet can take the form of header 500 of FIG. 5. Header 500 represents header 300 updated to include the time spent at each of the hubs as shown. For instance, the data packet spent 0.007 seconds at hub 1 and 0.026 seconds at hub 8 with a total time of transmission of 0.033 seconds.

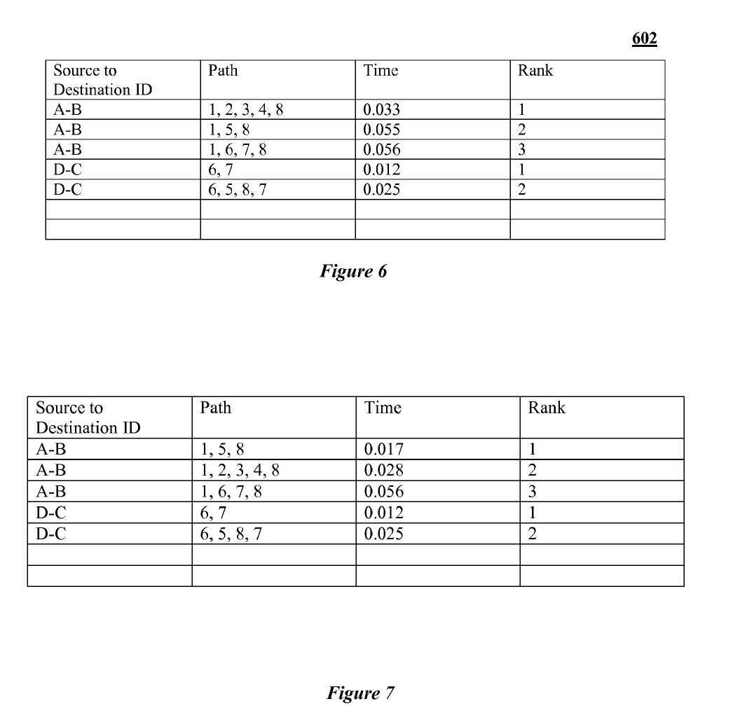

Reference now being made to FIG. 6, a diagram is shown illustrating a table 602 that is used by the arbiter 108 of FIG. 1 for saving path routing information received from a destination core according to the teachings of the preferred embodiment of the present invention. In the preferred embodiment of the present invention, the arbiter 108 includes memory (not shown) that can be used to store the table 602 that includes a source to destination field, a path field, a time field, and a rank field.

The source to destination field indicates the source core and destination core. The path field indicates the hubs (i.e., routing path) that the data packets will take when being transmitted to the destination core. The time field indicates the last recorded amount of time that a data packet following the indicated routing path took to reach the destination core from the source core. The rank field is used for indicating the relative rank of this row in the table 600 when compared to other rows having the same source and destination combination. In lieu of a rank field, the table 600 could be indexed on the time and source to destination field.

The table 600 includes all combinations for hub routing for any source to any destination core (not shown). As the destination cores provide the header information to the arbiter 108, the arbiter 108 updates the matching record (row) to reflect the new time and reset the ranks accordingly.

As an example, the table 600 indicates that for source core A to destination core B the fastest routing path is hubs 1, 2, 3, 4, and 8 via its rank. As time progresses, the table 600 could be updated as indicated in FIG. 7 to represent the data packets and sorted accordingly.

It should be noted that although the preferred embodiment uses a table with rows and columns, that any suitable data structure technique (e.g., link lists) could be used to track the fields noted above so that they can be accessed quickly and indexed appropriately.

The scheme used for determining which one of the path routing records to provide in response to a request for a particular source core and destination core can depend upon such things as hubs along the route path being available to transmit the packet data. If one or more of the hubs in the highest rank record for the route path indicate source to destination are unavailable, then the arbiter 108 selects the next highest rank record for this source to destination combination until it finds one that has the hubs available for this transaction.

The transmission of data packets from a source core to the indicated routing path provided by the arbiter 108 is explained below.

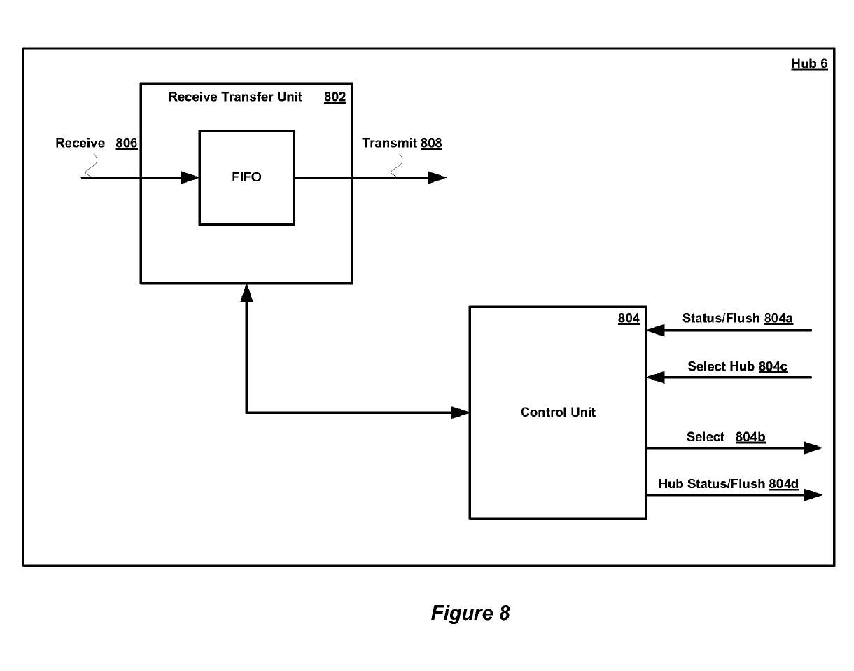

Reference now being made to FIG. 8, a schematic diagram is shown illustrating in greater detail the hub 6 of FIG. 1 according to the teachings of the preferred embodiment of the present invention. Hubs 1-8 are structurally equivalent one to another, and therefore, the discussion with respect to hub 6 is equally applicable to hubs 1-8. Hub 6 includes a receive/transfer unit 802 and a control unit 804.

The receive/transfer unit 802 receives, stores and transmits data packets from other adjacent hubs and cores via receive and transmit data lines 806 and 808, respectively. Data packets are stored in the First In First Out (FIFO) memory mechanism as they are received and stored until they are either discarded or transmitted.

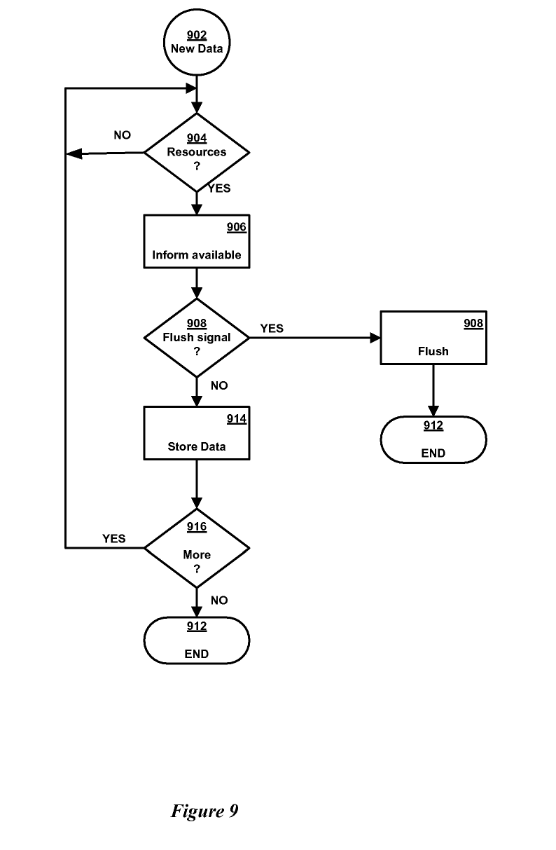

Control unit 804 manages the receipt and transmission of packet data by the receive/transfer unit 802 according to signals status/flush 804a, select hub 804c, select 804b, and hub status/flush 804d in accordance with the flow chart of FIG. 9.

Reference now being made to FIG. 9, a flow chart is shown illustrating the method used by a hub such as hub 6 of FIG. 1 for receiving packet data from an adjacent hub or core according to the teachings of the preferred embodiment of the present invention. Continuing with the explanation of hub 6, the receipt of data packets by hub 6 begins when an adjacent hub or source core asserts the hub select signal 804c (Step 902). The control unit 804 verifies that the FIFO of the receive/transfer unit 802 has sufficient resources to receive the incoming packet data (Step 904).

If there are insufficient resources the control unit 804 notifies the adjacent hub or source core that hub 6 is currently busy via hub status/flush signal 804d. If sufficient resources exist then the control unit 804 notifies the adjacent hub or source core to transmit data packets (Step 906).

In an embodiment of the present invention, a hub or source core can simultaneously transmit multiple copies of the data when transmission is considered critical. When a hub or source core initiates multiple instantiations of the same data packets, unique identifiers are included in the header to indicate the instantiation to which the data packet belongs and that there are multiple instantiations. As a destination core receives a data packet, it records this until the data transmission has been completed.

As explained below in connection with the receipt of data packets by a destination core, the destination core provides the headers of received data packets to the arbiter 108. The arbiter 108 tracks when multiple instances of the same data is being transmitted, and upon receiving header information on the data packets for the first instance to reach the destination core, the arbiter 108 informs all other hubs that are holding or transmitting the other instance(s) to flush their FIFOs of these redundant data packet instances via the status/flush signal 804a (Steps 906-908, and 918).

Received data packets are stored in the FIFO (Step 914). If the select hub signal 804c is still selected, then the source core or adjacent hub desires to send more packet data and the receipt of packet data proceeds back to step 302 and repeats the method from that point; otherwise, the receipt of the packet data ends (Step 918) information.

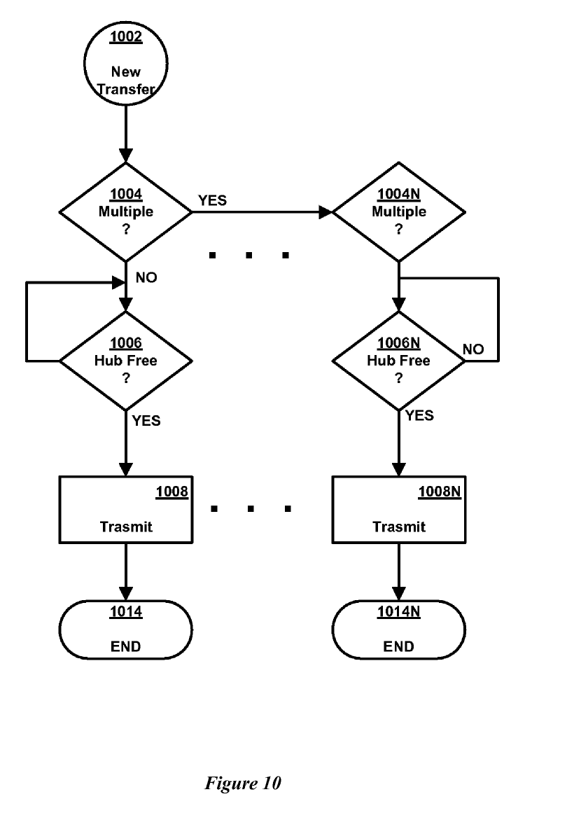

Reference now being made to FIG. 10, a flow chart is shown illustrating the transmission of data packets by a hub of FIG. 1 according to the teachings of an embodiment of the present invention. The control unit 804 processes any data packets stored in the FIFO according to any priorities that may be indicated in the headers of the data packets.

As previously discussed, the arbiter 108 may inform the hub that when it receives a certain data packet as identified with header information that the data packet should be transmitted to multiple adjacent hubs (Step 404).

The control unit 804 checks whether an adjacent hub is available for receipt of data packets by asserting the status/flush signal 804d (406n). If the status/flush signal 804a indicates that the adjacent hub is available then the control unit 804 instructs the receive/transfer unit 802 to transmit the data packets in the FIFO (Steps 1012-1014).

If the status/flush signal 804a indicates that the adjacent hub is busy then the control unit 804 waits a predetermined period of time and attempts the transmission again (Step 1006).

It should be noted, as the transmission of the data packets proceeds and if it were part of a multiple instantiation, that a flush signal can be received from the arbiter 108 via the status/flush signal 804a. If a flush signal is received the control unit 804 instructs the receive/transfer unit 802 to flush the indicated data packets stored in the FIFO.

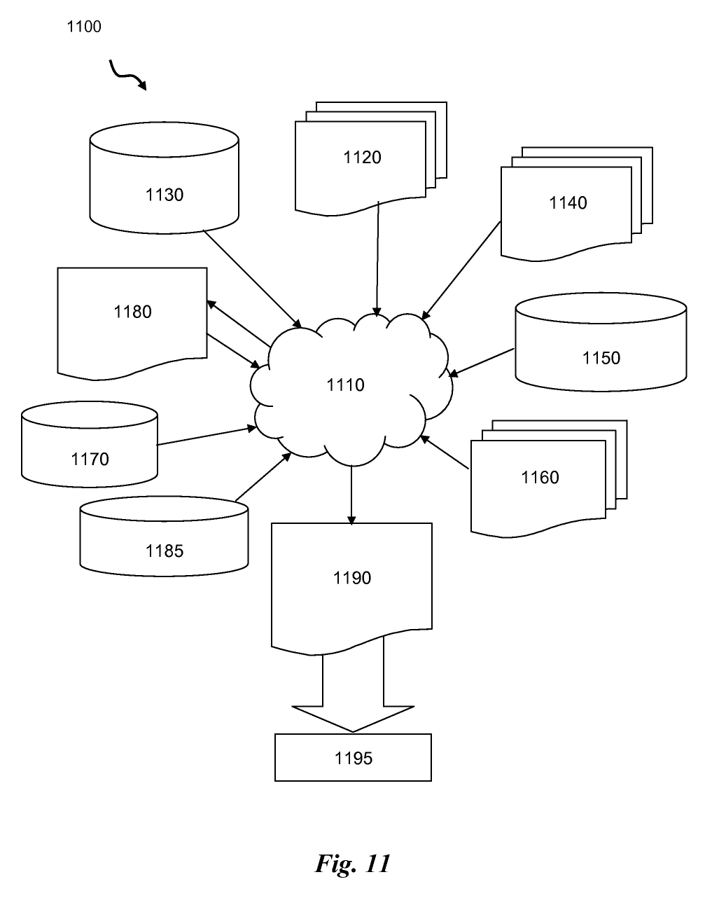

FIG. 11 shows a block diagram of an exemplary design flow 1100 used for example, in semiconductor IC logic design, simulation, test, layout, and manufacture. Design flow 1100 includes processes and mechanisms for processing design structures or devices to generate logically or otherwise functionally equivalent representations of the design structures and/or devices described above and shown in FIGS. 1 and/or 2. The design structures processed and/or generated by design flow 1100 may be encoded on machine-readable transmission or storage media to include data and/or instructions that when executed or otherwise processed on a data processing system generate a logically, structurally, mechanically, or otherwise functionally equivalent representation of hardware components, circuits, devices, or systems. Design flow 1100 may vary depending on the type of representation being designed. For example, a design flow 1100 for building an application specific IC (ASIC) may differ from a design flow 1100 for designing a standard component or from a design flow 1100 for instantiating the design into a programmable array, for example a programmable gate array (PGA) or a field programmable gate array (FPGA) offered by Altera® Inc. or Xilinx® Inc.

FIG. 11 illustrates multiple such design structures including an input design structure 1120 that is preferably processed by a design process 1110. Design structure 1120 may be a logical simulation design structure generated and processed by design process 1110 to produce a logically equivalent functional representation of a hardware device. Design structure 1120 may also or alternatively comprise data and/or program instructions that when processed by design process 1110, generate a functional representation of the physical structure of a hardware device. Whether representing functional and/or structural design features, design structure 1120 may be generated using electronic computer-aided design (ECAD) such as implemented by a core developer/designer. When encoded on a machine-readable data transmission, gate array, or storage medium, design structure 1120 may be accessed and processed by one or more hardware and/or software modules within design process 1110 to simulate or otherwise functionally represent an electronic component, circuit, electronic or logic module, apparatus, device, or system such as those shown in FIGS. 1 and/or 2. As such, design structure 1120 may comprise files or other data structures including human and/or machine-readable source code, compiled structures, and computer-executable code structures that when processed by a design or simulation data processing system, functionally simulate or otherwise represent circuits or other levels of hardware logic design. Such data structures may include hardware-description language (HDL) design entities or other data structures conforming to and/or compatible with lower-level HDL design languages such as Verilog and VHDL, and/or higher level design languages such as C or C++.

Design process 1110 preferably employs and incorporates hardware and/or software modules for synthesizing, translating, or otherwise processing a design/simulation functional equivalent of the components, circuits, devices, or logic structures shown in [fill in figure or figures that represent the design] to generate a netlist 1180 which may contain design structures such as design structure 1120. Netlist 1180 may comprise, for example, compiled or otherwise processed data structures representing a list of wires, discrete components, logic gates, control circuits, I/O devices, models, etc. that describes the connections to other elements and circuits in an integrated circuit design. Netlist 1180 may be synthesized using an iterative process in which netlist 1180 is resynthesized one or more times depending on design specifications and parameters for the device. As with other design structure types described herein, netlist 1180 may be recorded on a machine-readable data storage medium or programmed into a programmable gate array. The medium may be a non-volatile storage medium such as a magnetic or optical disk drive, a programmable gate array, a compact flash, or other flash memory. Additionally, or in the alternative, the medium may be a system or cache memory, buffer space, or electrically or optically conductive devices and materials on which data packets may be transmitted and intermediately stored via the Internet, or other networking suitable means.

Design process 1110 may include hardware and software modules for processing a variety of input data structure types including netlist 1180. Such data structure types may reside, for example, within library elements 1130 and include a set of commonly used elements, circuits, and devices, including models, layouts, and symbolic representations, for a given manufacturing technology (e.g., different technology nodes, 32 nm, 45 nm, 90 nm, etc.). The data structure types may further include design specifications 1140, characterization data 1150, verification data 1160, design rules 1170, and test data files 1185 which may include input test patterns, output test results, and other testing information. Design process 1110 may further include, for example, standard mechanical design processes such as stress analysis, thermal analysis, mechanical event simulation, process simulation for operations such as casting, molding, and die press forming, etc. One of ordinary skill in the art of mechanical design can appreciate the extent of possible mechanical design tools and applications used in design process 1110 without deviating from the scope and spirit of the invention. Design process 1110 may also include modules for performing standard circuit design processes such as timing analysis, verification, design rule checking, place and route operations, etc.

Design process 1110 employs and incorporates logic and physical design tools such as HDL compilers and simulation model build tools to process design structure 1120 together with some or all of the depicted supporting data structures along with any additional mechanical design or data (if applicable), to generate a second design structure 1190. Design structure 1190 resides on a storage medium or programmable gate array in a data format used for the exchange of data of mechanical devices and structures (e.g. information stored in a IGES, DXF, Parasolid XT, JT, DRG, or any other suitable format for storing or rendering such mechanical design structures). Similar to design structure 1120, design structure 1190 preferably comprises one or more files, data structures, or other computer-encoded data or instructions that reside on transmission or data storage media and that when processed by an ECAD system generate a logically or otherwise functionally equivalent form of one or more of the embodiments of the invention shown in FIGS. 1 and/or 2. In one embodiment, design structure 1190 may comprise a compiled, executable HDL simulation model that functionally simulates the devices shown in FIGS. 1 and/or 2.

Design structure 1190 may also employ a data format used for the exchange of layout data of integrated circuits and/or symbolic data format (e.g. information stored in a GDSII (GDS2), GLI, OASIS, map files, or any other suitable format for storing such design data structures). Design structure 1190 may comprise information such as, for example, symbolic data, map files, test data files, design content files, manufacturing data, layout parameters, wires, levels of metal, vias, shapes, data for routing through the manufacturing line, and any other data required by a manufacturer or other designer/developer to produce a device or structure as described above and shown in FIGS. 1 and/or 2. Design structure 1190 may then proceed to a stage 1195 where, for example, design structure 1190: proceeds to tape-out, is released to manufacturing, is released to a mask house, is sent to another design house, is sent back to the customer, etc.

It is thus believed that the operation and construction of the present invention will be apparent from the foregoing description. While the method and system shown and described has been characterized as being preferred, it will be readily apparent that various changes and/or modifications could be made without departing from the spirit and scope of the present invention as defined in the following claims.

What is claimed is:

1. A method in a computer-aided design system for generating a functional design model for transmitting data in an integrated circuit, the method comprising:
creating multiple cores that implement a desired function; creating multiple hubs that transmit data between the cores;
creating a table that contains all valid path routings for data to travel from a source core of the multiple cores to a destination core of the multiple cores using one or more of the hubs;
selecting one of the valid path routings for transmitting data from a first source core to a first destination core; and
transmitting the data according to the selected path routing from the first source core to the first destination core.

2. The method of claim 1 wherein the step of creating a table includes the step of:
organizing the table according to a predetermined prioritization scheme.

3. The method of claim 2 wherein the step of selecting one of the valid path routings includes the step of:
selecting one of the valid path routings based upon whether the hubs in the routing path are available.

4. The method of claim 1 further comprising the step of:
transmitting a request from a first source core to an arbiter, the request being to transmit data from the first source core to a first destination core.

5. The method of claim 4 wherein the step of selecting one of the valid path routings includes the step of:
selecting, in response to receiving the request, one of the valid path routings, wherein the step of selecting is performed by the arbiter.

6. The method of claim 5 wherein the step of transmitting the data includes the step of:
transmitting the selected path routing to the first source core.

7. The method of claim 6 wherein the step of transmitting the data includes the steps of:
transmitting the data from the first source core to a first one of the hubs according to the selected path, the data including header information for describing the selected path routing;
receiving the data from the first one of the hubs in another one of the hubs or the first destination core; and
reading the header information to determine the next hub or the first destination core to receive the data, or sending the header to the arbiter if data is at the first destination core.

8. A hardware description language (HDL) design structure encoded on a machine-readable data storage medium, said HDL design structure comprising elements that when processed in a computer-aided design system generates a machine-executable representation of a multi-core transmission system, wherein said HDL design structure comprises:
multiple cores that implement a desired function; multiple hubs that transmit data between the cores;
means for creating a table that contains all valid path routings for data to travel from a source core of the multiple cores to a destination core of the multiple cores using one or more of the hubs;
means for selecting one of the valid path routings for transmitting data from a first source core to a first destination core; and
means for transmitting the data according to the selected path routing from the first source core to the first destination core.

9. The HDL design structure of claim 8 wherein the means for creating a table comprises:
means for organizing the table according to a predetermined prioritization scheme.

10. The HDL design structure of claim 11 wherein the means for selecting one of the valid path routings includes:
means for selecting one of the valid path routings based upon whether the hubs in the routing path are available.

11. The HDL design structure of claim 8 further comprising:
means for transmitting a request from a first source core to an arbiter, the request being to transmit data from the first source core to a first destination core.

12. The HDL design structure of claim 11 wherein in the means for selecting one of the valid path routings includes:
means for selecting, in response to receiving the request, one of the valid path routings,
wherein the means for selecting is performed by the arbiter.

13. The HDL design structure of claim 12 wherein the means for transmitting the data includes:
means for transmitting the selected path routing to the first source core.

14. The HDL design structure of claim 13 wherein the means for transmitting the data includes:
means for transmitting the data from the first source core to a first one of the hubs the data including header information for describing the selected path routing;
means for receiving the data from the first one of the hubs, in another one of the hubs or the first destination core; and
reading the header information to determine the next hub or the first destination core to receive the data, or sending the header to the arbiter if data is at the first destination core.

15. A design structure tangibly embodied in a machine readable medium for designing, manufacturing, or testing an integrated circuit, the design structure comprising:
a source core that implements a desired function;
a destination core that implements a desired function and requires data from the source core;
a plurality of hubs, located between the source and destination cores, each being capable of receiving and transmitting data packets according to routing information provided in a header of the data packet; and
an arbiter that maintains a table of all possible routing paths for transmitting data packets from the source core to the destination core using the hubs.

16. The design structure of claim 15 wherein the table is organized according to a predetermined scheme.

17. The design structure of claim 16 wherein the table is organized according to the amount of time a packet of data takes to travel each routing path to the destination core.

18. The design structure of claim 17 wherein the table is updated with new timing information for the selected routing path as data packets are received by the destination core.

19. The design structure of claim 15, wherein the design structure comprises a netlist.

20. The design structure of claim 15, wherein the design structure resides on storage medium as a data format used for the exchange of layout data of integrated circuits.
